(19) United States
(12) Patent Application Publication
(10) Pub. No.: US 2025/0257480 A1
(43) Pub. Date: Aug. 14, 2025

(54) ELECTROCHEMICAL CELL STACKS AND SUBSTACKS AND METHODS OF FORMING ELECTROCHEMICAL CELL STACKS AND SUBSTACKS

(71) Applicant: ELECTRIC HYDROGEN CO., Devens, MA (US)

(72) Inventors: Jigish Trivedi, Pleasanton, CA (US); Marco Bertolotti, Somerville, MA (US); Scott Gentile, Framingham, MA (US); Jason Robinson, Hopedale, MA (US)

(21) Appl. No.: 18/996,938

(22) PCT Filed: Aug. 23, 2024
(86) PCT No.: PCT/US2024/043661

§ 371 Date: Jan. 17, 2025

Related U.S. Application Data
(60) Provisional application No. 63/535,522, filed on Aug. 30, 2023.

(51) Int. Cl. C25B 9/70; C25B 9/63

(52) U.S. Cl. CPC C25B 9/70; C25B 9/63

(57) ABSTRACT

The following disclosure relates to substacks configured to form an electrochemical stack. A substack for an electrochemical stack includes a plurality of electrochemical cells, each electrochemical cell having a cathode flow field, an anode flow field, and a membrane positioned between the cathode flow field and the anode flow field. The substack also includes an anode unipolar plate and a cathode unipolar plate, wherein the plurality of electrochemical cells is positioned between the anode unipolar plate and the cathode unipolar plate. The substack is configured to be independently tested for one or more performance parameters prior to addition to the electrochemical stack. The substack is also configured to be added to the electrochemical stack including at least one additional substack following achieving a threshold test result for the one or more performance parameters being tested.

This application claims the benefit of U.S. Provisional Patent Application No. 63/535,522, filed Aug. 30, 2023, which is hereby incorporated by reference in its entirety.

### FIELD

The following disclosure relates to electrochemical or electrolysis cell stacks and components thereof. More specifically, the following disclosure relates to electrochemical substacks configured to be independently tested for one or more performance parameters prior to addition to and formation of the electrochemical stack.

### BACKGROUND

Hydrogen has been considered as an ideal energy carrier to store renewable energy. Proton exchange membrane water electrolysis (PEMWE) as a means for hydrogen production offers high product purity, fast load response times, small footprints, high efficiencies, and low maintenance efforts. It is regarded as a promising technology, especially when coupled with renewable energy sources.

Electrochemical stacks for PEMWE are a key component in hydrogen production. In PEMWE, an electrochemical stack consists of multiple electrochemical cells that are stacked on top of one another. Stacking the electrochemical cells on top of one another may lead to large alignment tolerance errors, affecting the overall efficiency of the stack. Alignment tolerance errors can reduce the stack's overall performance and create inconsistencies in hydrogen production. Some cells might be operating optimally, while others may not, causing the overall system performance to be limited by the weakest cell in the stack.

Furthermore, when an electrochemical stack is not performing properly or efficiently, identifying a specific electrochemical cell causing the issue can be challenging. This is because the performance of each cell is interconnected, and isolating the problem to a single cell can be time-consuming and require extensive testing and analysis.

Therefore, there remains a desire for an improved method for forming and testing electrochemical stacks.

### SUMMARY

In one embodiment, a substack for an electrochemical stack is provided. The substack includes a plurality of electrochemical cells. Each electrochemical cell of the plurality of electrochemical cells includes a cathode flow field, an anode flow field, and a membrane positioned between the cathode flow field and the anode flow field. The substack also includes an anode unipolar plate and a cathode unipolar plate. The plurality of electrochemical cells is positioned between the anode unipolar plate and the cathode unipolar plate. The anode flow field of a first electrochemical cell abuts an internal surface of the anode unipolar plate. The cathode flow field of a second electrochemical cell abuts an internal surface of the cathode unipolar plate. The cathode flow field of the first electrochemical cell is positioned adjacent to the anode flow field of the second electrochemical cell. Alternatively, the anode flow field of an additional electrochemical cell positioned between the first and second electrochemical cells such that any additional electrochemical cells within the plurality of electrochemical cells are arranged where the anode flow field of a respective electrochemical cell is positioned adjacent to the cathode flow field of an adjacent electrochemical cell. The substack is configured to be independently tested for one or more performance parameters prior to addition to the electrochemical stack. The substack is also configured to be added to the electrochemical stack including at least one additional substack following achieving a threshold test result for the one or more performance parameters being tested.

In another embodiment an electrochemical stack is provided. The electrochemical stack includes a first manifold, and a second manifold. The electrochemical stack also includes a plurality of substacks stacked on top of one another and positioned between the first manifold and the second manifold. Each substack of the plurality of substacks includes a plurality of electrochemical cells. Each electrochemical cell of the plurality of electrochemical cells includes a cathode flow field, an anode flow field, and a membrane positioned between the cathode flow field and the anode flow field. Each substack also includes an anode unipolar plate and a cathode unipolar plate. The plurality of electrochemical cells is positioned between the anode unipolar plate and the cathode unipolar plate. The anode flow field of a first electrochemical cell abuts an internal surface of the anode unipolar plate. The cathode flow field of a second electrochemical cell abuts an internal surface of the cathode unipolar plate. The cathode flow field of the first electrochemical cell is positioned adjacent to the anode flow field of the second electrochemical cell. Alternatively, the anode flow field of an additional electrochemical cell positioned between the first and second electrochemical cells such that any additional electrochemical cells within the plurality of electrochemical cells are arranged where the anode flow field of a respective electrochemical cell is positioned adjacent to the cathode flow field of an adjacent electrochemical cell. The substack is configured to be independently tested for one or more performance parameters prior to addition to the electrochemical stack. The substack is also configured to be added to the electrochemical stack including at least one additional substack following achieving a threshold test result for the one or more performance parameters being tested. An anode unipolar plate of a first substack abuts an internal surface of the first manifold. A cathode unipolar plate of a second substack abuts an internal surface of the second manifold. The cathode unipolar plate of the first substack abuts the anode unipolar plate of the second substack or the anode unipolar plate of an additional substack positioned between the first and second substacks such that any additional substacks within the plurality of substacks are arranged where the anode unipolar plate of a respective substack is positioned adjacent to the cathode unipolar plate of an adjacent substack.

In another embodiment, a method for forming an electrochemical stack is provided. The method includes forming a plurality of substacks. Each substack includes an anode unipolar plate, a cathode unipolar plate, and a plurality of electrochemical cells positioned between the anode unipolar plate and the cathode unipolar plate. Each electrochemical cell of the plurality of electrochemical cells in the substack includes a cathode flow field, an anode flow field, and a membrane positioned between the cathode flow field and the anode flow field. The method also includes testing each substack of the plurality of substacks for one or more performance parameters. The method also includes identifying substacks of the plurality of substacks for addition to the electrochemical stack following achieving a threshold test result for the one or more performance parameters being tested for the respective substack. The method also includes inserting and aligning the substacks of the plurality of substacks that achieved the threshold test result on top of one another in the electrochemical stack to form the electrochemical stack. An anode unipolar plate of a first substack abuts an internal surface of a first manifold of the electrochemical stack. A cathode unipolar plate of a second substack abuts an internal surface of a second manifold of the electrochemical stack. The cathode unipolar plate of the first substack abuts the anode unipolar plate of the second substack or the anode unipolar plate of an additional substack positioned between the first and second substacks such that any additional substacks within the plurality of substacks are arranged where the anode unipolar plate of a respective substack is positioned adjacent to the cathode unipolar plate of an adjacent substack.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of an electrochemical cell.

FIG. 2 depicts an additional example of an electrochemical cell.

FIG. 3 depicts, in an exploded view, an example of a substack of an electrochemical stack.

FIG. 4 depicts, in an exploded view, another example of a substack for an electrochemical stack.

FIG. 5 depicts, in an exploded view, an example of an electrochemical stack including a plurality of substacks.

FIG. 6 depicts a flowchart describing an example process of forming an electrochemical stack with a plurality of substacks.

### DETAILED DESCRIPTION

The following disclosure provides an improved cell stack design and method for forming and testing electrochemical stacks. Specifically, the following disclosure provides substacks including a plurality of individual cells that are configured to form an electrochemical stack and configured to be independently tested for one or more performance parameters prior to addition to the electrochemical stack.

Electrochemical stacks may contain a large number of individual cells, which may be time-consuming and complex to test individually. Testing substacks having a plurality of individual cells reduces the number of individual tests needed, making the overall testing process simpler and quicker.

Substack-level testing also allows for the identification of performance-related issues at a higher level in the stack assembly. If a substack does not meet the required performance thresholds, it is easier to pinpoint the specific area or configuration that needs improvement.

Additionally, having an electrochemical stack designed with a modular approach, allows for the substacks to be easily added or removed, e.g., independently from one or more additional substacks present in the electrochemical stack. By testing substacks, it becomes easier to scale up or down the size and capacity of the electrochemical stack based on the desired application.

Testing substacks also enables quality control measures to be implemented effectively during the assembly process. It ensures that substacks meet the required performance standards before integrating them into the larger electrochemical stack.

Furthermore, if any issues arise during testing, it becomes simpler to isolate the problematic substack rather than individual cells. This simplifies the debugging and troubleshooting process.

Various substack and overall cell stack configurations and their methods of formation are provided in greater detail below.

### Definitions

As used herein, “cell isolation” may refer to the effectiveness of preventing interactions or interference between individual cells within the electrochemical stack or system. Cell isolation provides that each cell operates independently without cross-contamination, thus maintaining the integrity and accuracy of the electrochemical processes within each cell.

As used herein, “cross leak detection” may refer to the process of detecting a leak within one or more cells from the hydrogen/cathode side of the cell(s) across the membrane(s) to the oxygen/anode side of the cell(s), or vice versa (i.e., detecting a leak within one or more cells from the oxygen/anode side of the cell(s) across the membrane(s) to the hydrogen/cathode side of the cell(s). In other words, cross leak detection may refer to the identification of hydrogen in an oxygen-rich product stream on the anode side of the cell(s) or the identification of oxygen in a hydrogen-rich product stream on the cathode side of the cell(s).

As used herein, “hydrostatic leak detection” may refer to the process of preventing unintended escape or ingress of liquids or gases within the electrochemical system. It is essential for maintaining the integrity and safety of the electrochemical processes.

As used herein, “unipolar plate” may refer to a plate functioning exclusively as either an anode or a cathode plate but not assuming both roles simultaneously. In certain examples, the unipolar plate and adjacent flow field may be a single structure (i.e., the flow fields or channels are etched, carved, or otherwise formed on one surface of the plate).

As used herein, “bipolar plate” indicates a plate that serves as both an electrical conductor and a separator between individual cells within a stack or substack. A bipolar plate consists of a lightweight and durable material that is electrically conductive, such as graphite, metals (e.g. Ti), metal-coated composites, or certain polymers. In certain examples, the bipolar plate is positioned between an anode flow field and a cathode flow field of two adjacent electrochemical cells. In some instances, the bipolar plate and the adjacent flow fields may be a single structure (i.e., the flow fields or channels are etched, carved, or otherwise formed on both surfaces of the bipolar plate.

As used herein, testing a substack or stack at a “high current density” may refer to testing or operating the substack or stack for electrolysis at a current density of at least 3 Amp/cm2 at least 4 Amps/cm², at least 5 Amps/cm², at least 6 Amps/cm², at least 7 Amps/cm², at least 8 Amps/cm², at least 9 Amps/cm², at least 10 Amps/cm², or at least 11 Amps/cm², at least 12 Amps/cm², at least 13 Amps/cm², at least 14 Amps/cm², at least 15 Amps/cm², at least 16 Amps/cm², at least 17 Amps/cm², at least 18 Amps/cm², at least 19 Amps/cm², at least 20 Amps/cm², at least 25 Amps/cm², at least 30 Amps/cm², in a range of 1-30 Amps/cm², in a range of 3-30 Amps/cm², in a range of 3-20 Amps/cm², in a range of 3-15 Amps/cm², in a range of 3-10 Amps/cm², or in a range of 10-20 Amps/cm²) and evaluating how well the substack or stack performs and maintains stability when subjected to such a high current density.

### Electrochemical Cells

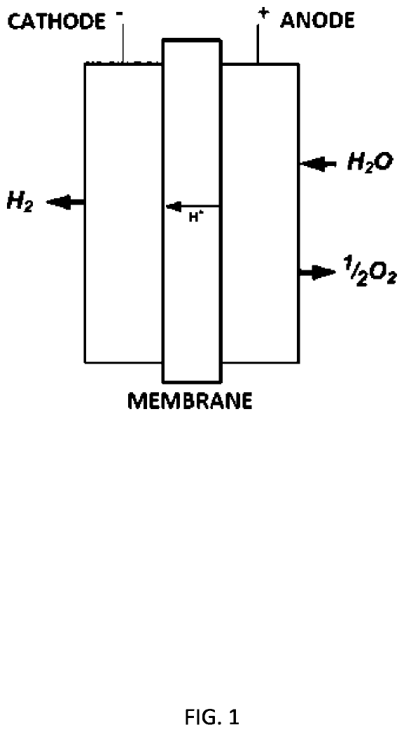

FIG. 1 depicts an example of an electrochemical or electrolytic cell for hydrogen gas and oxygen gas production through the splitting of water. The electrolytic cell includes a plurality of layers, such as a cathode, an anode, and a membrane positioned between the cathode and anode. The membrane may be a proton exchange membrane (PEM). Proton Exchange Membrane (PEM) electrolysis involves the use of a solid electrolyte or ion exchange membrane. Within the water splitting electrolysis reaction, one interface runs an oxygen evolution reaction (OER) while the other interface runs a hydrogen evolution reaction (HER). For example, the anode reaction is H₂O→2 H⁺+½O₂+2 e and the cathode reaction is 2 H⁺+2e→H₂. The water electrolysis reaction has recently assumed great importance and renewed attention as a potential foundation for a decarbonized “hydrogen economy.” Other types of electrolyzers may be used as well.

Since the performance of a single electrolytic cell may not be adequate for many use cases, multiple cells may be placed together to form a “stack” of cells, which may be referred to as an electrolyzer stack, electrolytic stack, electrochemical stack, or simply just a stack. In certain examples, a stack may contain 50-1000 cells, 50-100 cells, 50-200 cells, 500-700 cells, or more than 1000 cells. Any number of cells may make up an electrochemical stack.

The performance of an electrochemical stack may depend on multiple factors such as the performance of the electrochemical cells within the stack and the alignment of the electrochemical cells stacked on top of each other in the stack. Stack alignment tolerance may refer to the ability of an assembly or a stack of components to withstand variations, misalignments, or discrepancies without significantly affecting its performance or functionality. In certain examples, more cells contained in a stack can lead to greater discrepancies or misalignments of individual cells or layers of cells within the stack. For example, a stack containing 360 cells may have greater misalignment than a stack containing 10 cells because each cell (and each layer within an individual cell) may have slight variations in the alignment between one cell and the next (or one layer within one cell and an adjacent layer within the same cell). For example, presuming that the misalignment tolerance between individual cell layers is 10 microns (i.e., one cell layer may have a maximum misalignment in positioning with an adjacent cell layer in the stack). A worst case scenario for a 360 cell stack may be a 13.25 mm total misalignment between the top and bottom of the stack. A similar worst case scenario for a 10 cell stack may include a total misalignment of only 0.35 mm. As such, proper design and alignment of the components can help minimize such misalignment issues, resulting in a more robust and reliable stack. As discussed in greater detail below, this may be achieved through the configuration and formation of a plurality of substacks for an electrochemical stack. That is, the formation of 10 cell substacks that are stacked on top of each other to form a 360 total cell stack (i.e., 36 substacks) may advantageously avoid a 13.25 mm misalignment problem due to the constant resetting of any misalignment in cell layers through the substack formation.

The electrochemical cells within the electrochemical stack may be configured to operate with 200 mV or less of pure resistive loss when operating at a high current density (e.g., at least 3 Amp/cm2 at least 4 Amps/cm², at least 5 Amps/cm², at least 6 Amps/cm², at least 7 Amps/cm², at least 8 Amps/cm², at least 9 Amps/cm², at least 10 Amps/cm², or at least 11 Amps/cm², at least 12 Amps/cm², at least 13 Amps/cm², at least 14 Amps/cm², at least 15 Amps/cm², at least 16 Amps/cm², at least 17 Amps/cm², at least 18 Amps/cm², at least 19 Amps/cm², at least 20 Amps/cm², at least 25 Amps/cm², at least 30 Amps/cm², in a range of 1-30 Amps/cm², in a range of 3-30 Amps/cm², in a range of 3-20 Amps/cm², in a range of 3-15 Amps/cm², in a range of 3-10 Amps/cm², or in a range of 10-20 Amps/cm²). In additional examples, the amount of water (e.g., deionized (DI) water) transferred to or circulated through each cell of the stack may be in a range of 0.25-1 mL/Amp/cell/min, in a range of 0.25-5 mL/Amp/cell/min, or in a range of 0.5-1 mL/Amp/cell/min.

Further, the electrochemical cells within the electrochemical stack may be used in the formation of a large-scale electrochemical plant that may be configured to generate at least 1 megawatt (MW) of power, at least 5 MW, at least 10 MW, at least 25 MW, at least 50 MW, at least 75 MW, at least 100 MW, 1-100 MW, 10-100 MW, 25-100 MW, or 50-100 MW.

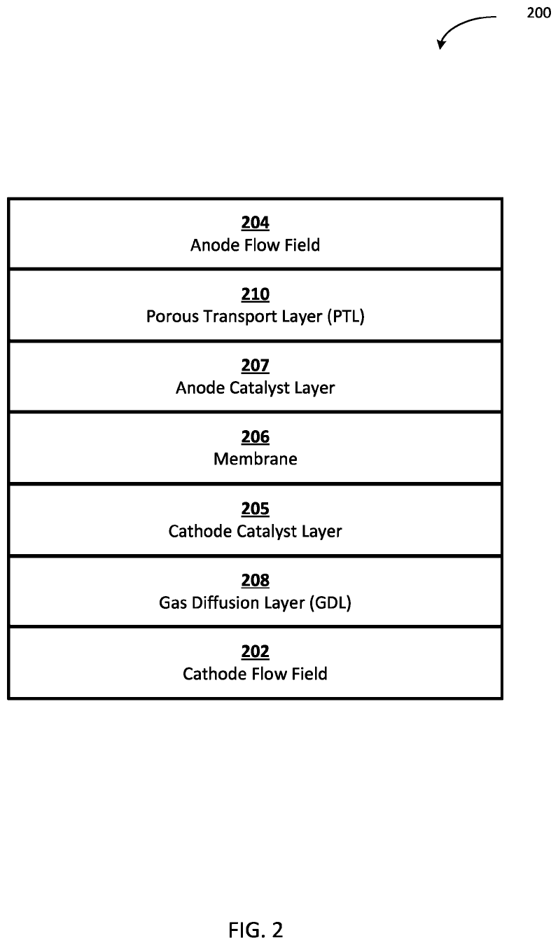

FIG. 2 depicts an additional example of an electrochemical or electrolytic cell. Specifically, FIG. 2 depicts a portion of an electrochemical cell 200 having a cathode flow field 202, an anode flow field 204, and a membrane 206 positioned between the cathode flow field 202 and the anode flow field 204.

In certain examples, the membrane 206 may be a catalyst coated membrane (CCM) having a cathode catalyst layer 205 and/or an anode catalyst layer 207 positioned on respective surfaces of the membrane 206. As used throughout this disclosure, the term “membrane” may refer to a catalyst coated membrane (CCM) having such catalyst layers. In certain examples, the membrane 206 (that, in some examples, may include the anode catalyst layer 207 and cathode catalyst layer 205) may have an overall thickness that is less than 1000 microns, 500 microns, 100 microns, 50 microns, 10 microns, etc.

In certain examples, additional layers may be present within the electrochemical cell 200. These additional layers may include porous media sandwiching the CCM and configured to facilitate the transport of fluids (i.e., water to the electrodes and gases from the electrodes) as well as provide electrical conductivity to the electrodes.

For example, one or more additional layers 208 may be positioned between the cathode flow field 202 and membrane 206. In certain examples, this may include a gas diffusion layer (GDL) 208 may be positioned between the cathode flow field 202 and membrane 206. This may be advantageous in providing a hydrogen diffusion barrier adjacent to the cathode on one side of the multi-layered membrane to mitigate hydrogen crossover to the anode side. In other words, the GDL is a porous media responsible for the transport of gaseous hydrogen to the cathode side flow field. For a wet cathode PEM operation, liquid water transport across the GDL is needed for heat removal in addition to heat removal from the anode side. In certain examples, the GDL 208 may be made of carbon fibers. In certain examples, the thickness of the GDL 208 may be in a range of 100-1000 microns.

Similarly, one or more additional layers 210 may be present in the electrochemical cell between the membrane 206 and the anode 204. In certain examples, this may include a porous transport layer (PTL) positioned between the membrane 206 (e.g., the anode catalyst layer 207 of the catalyst coated membrane 206) and the anode flow field 204.

Similar to the GDL, the PTL is a porous media configured to allow the transportation of the reactant water to the anode catalyst layers, remove produced oxygen gas, and provide good electrical conductivity for effective electron conduction. In other words, liquid water flowing in the anode flow field is configured to permeate through the PTL to reach the CCM. Further, gaseous byproduct oxygen is configured to be removed from the PTL to the flow fields. In such an arrangement, liquid water functions as both reactant and coolant on the anode side of the cell.

The cathode flow field 202 and anode flow field 204 of the cell may individually include a flow field plate composed of metal, carbon, or a composite material having a set of channels machined, stamped, or etched into the plate to allow fluids to flow inward toward the membrane or out of the cell.

### Electrochemical Substack

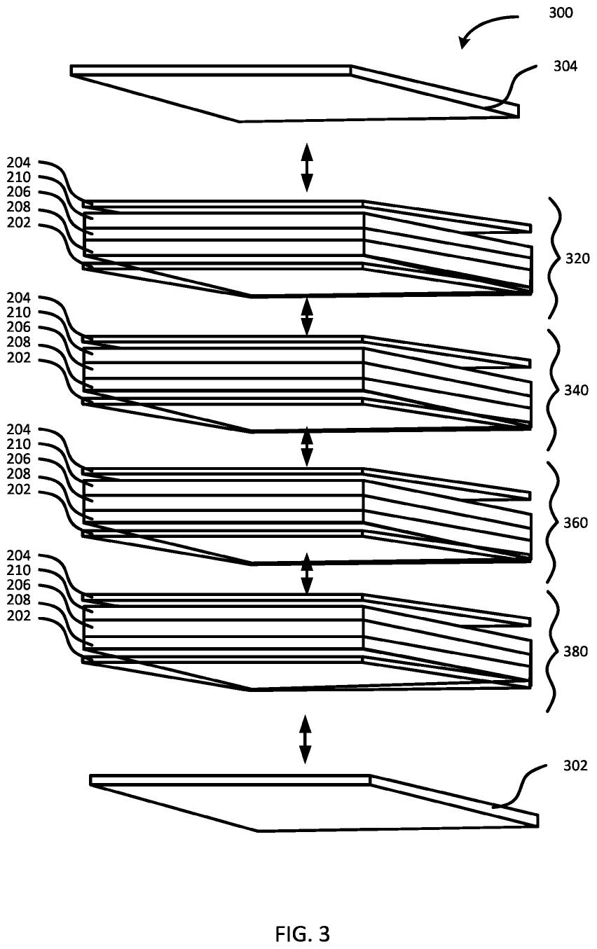

FIG. 3 depicts, in an exploded view, an example of a substack 300 of an electrochemical stack. The substack 300 includes four electrochemical cells stacked on top of one another (e.g., connecting, abutting, or the like): a first electrochemical cell 320, a second electrochemical cell 340, a third electrochemical cell 360, and a fourth electrochemical cell 380.

In certain examples, the substack 300 is not limited to four electrochemical cells. Instead, the substack may include any plurality of electrochemical cells. For example, a substack may include at least 2 cells, at least 3 cells, at least 4 cells, at least 5 cells, at least 10 cells, less than or equal to 100 cells, less than or equal to 50 cells, less than or equal to 30 cells, less than or equal to 25 cells, less than or equal to 20 cells, in a range of 2-100 cells, in a range of 3-50 cells, in a range of 4 to 30 cells, in a range of 5-25 cells, or in a range of 10-20 cells stacked on top of one another in the electrochemical system to provide an electrochemical stack.

Similar to the example discussed above in FIG. 2, each electrochemical cell (i.e., electrochemical cells 320, 340, 360, and 380) of the substack 300 includes a cathode flow field 202, an anode flow field 204, and a membrane 206 positioned between the cathode flow field 202 and the anode flow field 204. As noted above, the cathode flow field 202 and anode flow field 204 of each cell may individually include a flow field plate composed of metal, carbon, or a composite material having a set of channels machined, stamped, or etched into the plate to allow fluids to flow inward toward the membrane or out of the cell.

In certain examples, each cell may include additional layers such as a gas diffusion layer (GDL) and a porous transport layer (PTL), such as those layers described with reference to the electrochemical cell in FIG. 2. For instance, the GDL may be positioned between the cathode flow field 202 and the membrane 206. On the opposite side of the cell, the PTL 210 may be present in each electrochemical cell between the membrane 206 and the anode 204. Additionally, in certain examples, the membrane 206 may be a catalyst coated membrane (CCM) having a cathode catalyst layer 205 and/or an anode catalyst layer 207 positioned on respective surfaces of the membrane 206. However, in terms of simplicity, these additional layers are not illustrated in FIG. 3.

As mentioned above, the substack 300 includes multiple cells stacked on top of one another. More particularly, the first electrochemical cell 320 is stacked on top of a second electrochemical cell 340. The second electrochemical cell 340 is stacked on top of the third electrochemical cell 360, and the third electrochemical cell 360 is stacked on top of the fourth electrochemical cell 380.

As depicted in FIG. 3, the cathode flow field 202 of the first electrochemical cell 320 is positioned adjacent to the anode flow field 204 of the second electrochemical 340. The cathode flow field 202 of the second electrochemical cell 340 is positioned adjacent to the anode flow field 204 of the third electrochemical cell 460. Additionally, the cathode flow field 202 of the third electrochemical cell 360 is positioned adjacent to the anode flow field of the fourth electrochemical cell 380.

The substack 300 also includes two unipolar plates: a cathode unipolar plate 302 and an anode unipolar plate 304, positioned on opposite ends of the substack 300, therein serving as the termination points for the substack's electrical connection.

In other words, the multiple cells (i.e., 320, 340, 360, and 380) are positioned between the anode unipolar plate 304 and the cathode unipolar plate 302, such as to enclose the plurality of cells. For example, the anode flow field 204 of the first electrochemical cell 320 abuts the internal surface of the anode unipolar plate 304. As noted above, the anode flow field 204 and the anode unipolar plate 304 may be a single structure (i.e., the flow fields or channels are etched, carved, or otherwise formed on one surface of the anode unipolar plate).

Likewise, the cathode flow field 202 of the fourth electrochemical cell 380 abuts the internal surface of the cathode unipolar plate 302. Again, in some examples, the cathode flow field 202 and the cathode unipolar plate 302 may be a single structure (i.e., the flow fields or channels are etched, carved, or otherwise formed on one surface of the anode unipolar plate).

The unipolar plates may be made of any metal or metal alloy. In one particular example, the unipolar plates include titanium or a titanium alloy, which may advantageously provide strength and durability at a small thickness, therein not unduly increasing the height of the substack and overall stack. Specifically, in some examples, the thickness or height of each unipolar plate may be at least 0.1 mm, at least 1 mm, less than or equal to 10 mm, less than or equal to 5 mm, less than or equal to 3 mm, in a range of 0.1-10 mm, in a range of 1-5 mm, or in a range of 1-3 mm.

The unipolar plates advantageously enclose the plurality of cells to form the substack 300. The configuration of the substack 300 advantageously allows the substack 300 to be independently tested for performance parameters and to be added to an electrochemical stack including at least one additional substack when the test results/performance of the substack are acceptable (discussed further below). Furthermore, when the substack 300 fails one or more tests, the substack may not be added to the overall stack, and instead placed aside for potential further examination to identify a potential problematic cell within the substack. Additionally, in some examples, an individual substack may be removed and replaced within an electrochemical stack over a period of time of operation of the stack, or when it has been otherwise identified that there may be a problem with the substack. In other words, the substack may be removed as an individual assembly separately and independently from one or more additional substacks present in the electrochemical stack.

For instance, in a stack containing multiple cells, identifying the specific electrochemical cell causing any performance issues or inefficiencies can be challenging. The interconnected nature of each cell's performance makes it time-consuming and analytically demanding to isolate the problem to a single cell, requiring extensive testing.

However, with multiple substacks, each configured for independent testing of performance parameters and containing a predetermined number of electrochemical cells, identifying and isolating the problematic cell becomes much more straightforward. For example, only testing the overall cell stack that has 360 cells will be challenging to identify a problem with one or more cells in the 360 total cell count. Alternatively, having 36 substacks of 10 cells each will increase the amount of initial testing (36 tests vs 1 test), but more quickly identify problematic cells. That is, if there are 5 problematic cells in the 360 cell stack, there will be at least 31 of 36 substacks that pass their initial testing and are approved for addition to the overall stack.

Additionally, the formation of substacks alleviates a concern of testing each individual cell independently from the others (e.g., having 360 initial performance tests). In other words, by testing substacks of cells rather than testing every individual electrochemical cell, the process is also streamlined, making it easier to identify and address any performance-related issues in the electrochemical stack efficiently.

In certain examples, the substacks of cells may be tested or examined for specific performance parameters such as cell layer alignment, cell isolation, cross-leak detection, hydrostatic leak detection, and/or electrolysis at a current density greater than or equal to 3 Amp/cm². In other words, each substack may be configured to be independently tested or examined for cell layer alignment, cell isolation, cross-leaks, hydrostatic leaks, electrolysis at a current density greater than or equal to 3 Amp/cm², or a combination thereof. Upon achieving a predefined threshold result for an individual test (i.e., passing the test) for each specific performance parameter, the substack may be added to the overall cell stack (or otherwise identified as capable of being added to the cell stack). Upon failing one or more individual tests (i.e., not achieving a predefined threshold result), the substack may be identified for further testing or disassembly to examine one or more cells within the stack to identify the issue.

### Electrochemical Substack Having Bipolar Plates

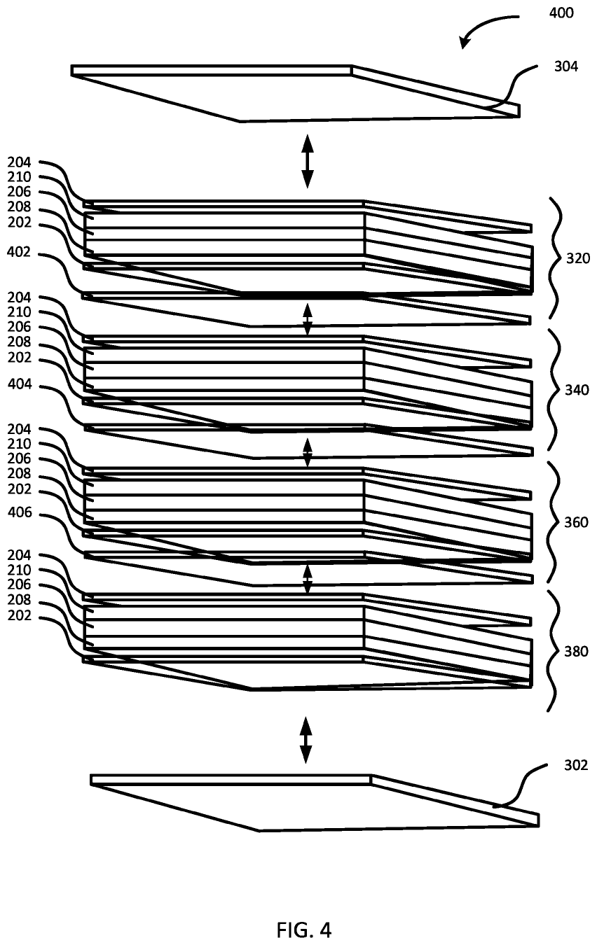

FIG. 4 depicts, in an exploded view, another embodiment of a substack for an electrochemical stack. The substack 400 includes a plurality of bipolar plates positioned between adjacent cells of the substack 400. Specifically, a bipolar plate may be positioned at an interface between an anode flow field and a cathode flow field of respective adjacent electrochemical cells within the group of electrochemical cells. As noted above, in certain examples, the bipolar plate and adjacent flow fields may be a single structure (i.e., the flow fields or channels are etched, carved, or otherwise formed on both surfaces of the bipolar plate.

FIG. 4 depicts a substack 400 including four electrochemical cells stacked on top of one another, such as depicted in FIG. 3 and described above. FIG. 4 also depicts three bipolar plates, such that each cell is separated from an adjacent cell in the substack by a supporting plate (i.e., the unipolar plates on the ends of the substack and the bipolar plates between the cells of the substack).

In certain alternative examples, while not depicted, not every cell in a substack may be separated from an adjacent cell in the substack by such a plate.

As shown in FIG. 4, the substack 400 includes a first bipolar plate 402, a second bipolar plate 404, and a third bipolar plate 406. The first bipolar plate 402 is positioned between the cathode flow field 202 of the first electrochemical cell 320 and the anode flow field 204 of the second electrochemical cell 340 (in certain examples, the anode flow field 204, the bipolar plate 402 and the cathode flow 202 may be a single structure (i.e., the flow fields or channels are etched, carved, or otherwise formed on both surfaces of the bipolar plate 402).

The second bipolar plate 404 is positioned between the cathode flow field 202 of the second electrochemical cell 340 and the anode flow field 204 of the third electrochemical cell 360. The third bipolar 406 plate is positioned between the cathode flow field 202 of the third electrochemical cell 360 and the anode flow field 204 of the fourth electrochemical cell 380.

The bipolar plates may be made of any metal or metal alloy. In one particular example, the bipolar plates include titanium or a titanium alloy, which may advantageously provide strength and durability at a small thickness, therein not unduly increasing the height of the substack and overall stack. Specifically, in some examples, the thickness or height of each bipolar plate may be at least 0.1 mm, at least 1 mm, less than or equal to 10 mm, less than or equal to 5 mm, less than or equal to 3 mm, in a range of 0.1-10 mm, in a range of 1-5 mm, or in a range of 1-3 mm.

### Electrochemical Stack Including a Plurality of Substacks

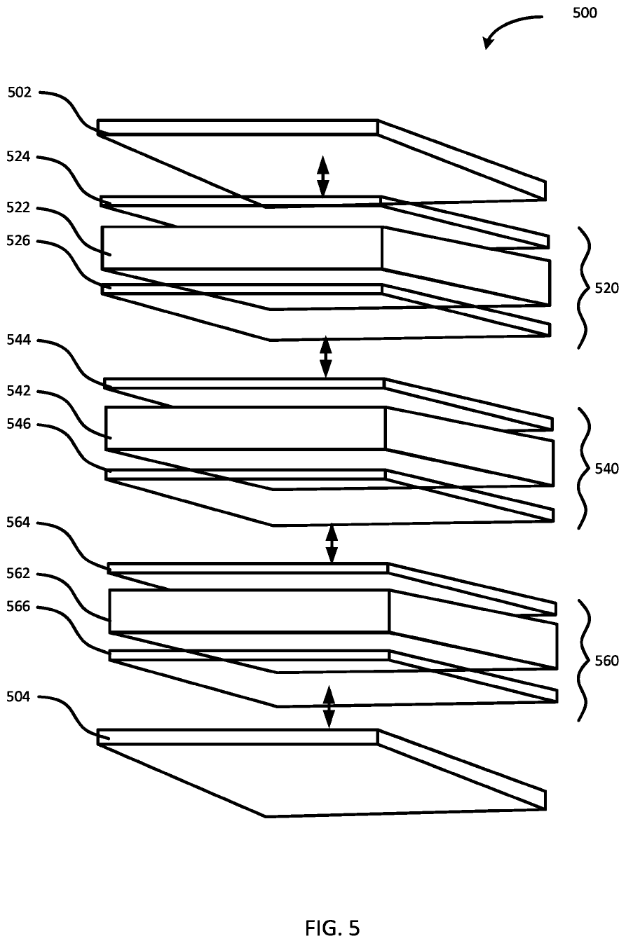

FIG. 5 depicts an example of an electrochemical stack 500 including a plurality of substacks. The electrochemical stack 500 also includes a first manifold 502 and a second manifold 504 positioned on opposite ends of the stack 500 such that the plurality of substacks are positioned between the two manifolds. The first manifold 502 and the second manifold 504 are responsible for directing the flow of reactant fluids (water) to the electrochemical cells and collecting the product gases (hydrogen and oxygen) from the cells.

As depicted in FIG. 5, the electrochemical stack 500 includes three substacks: a first substack 520, a second substack 540, and a third substack 560. While three substacks are depicted in this example, the electrochemical stack is not limited to such an arrangement. Instead, the electrochemical stack may include any number of substacks stacked on top of one another (e.g., connecting, abutting, or the like). In other words, the electrochemical stack may include at least 2 substacks, at least 3 substacks, at least 4 substacks, at least 5 substacks, at least 10 substacks, less than or equal to 100 substacks, less than or equal to 50 substacks, less than or equal to 30 substacks, less than or equal to 25 substacks, less than or equal to 20 substacks, in a range of 2-100 substacks, in a range of 3-50 substacks, in a range of 4 to 30 substacks, in a range of 5-25 substacks, or in a range of 10-20 substacks. In some examples, the number of substacks within an overall cell stack may be dictated by the desirable total number of cells in the stack. For example, if the total number of cells needed for the overall stack is 200 cells and the substacks include 10 cells per substack, then 20 substacks are needed for the overall stack.

In FIG. 5, each substack depicts its plurality of cells as one layer in terms of simplicity and its two unipolar plates as two separate layers. In other words, substack 520 depicts the plurality of cells as layer 522, which is positioned between its respective anode unipolar plate 524 and its respective cathode unipolar plate 526.

Likewise, substack 540 depicts the plurality of cells as layer 542, which is positioned between its respective anode unipolar plate 544 and its respective cathode unipolar plate 546. Similarly, substack 560 depicts the plurality of cells as layer 562, which is positioned between its respective anode unipolar plate 564 and its respective cathode unipolar plate 566.

The substacks 520, 540, and 560 are stacked on top of one another in between the first manifold 502 and the second manifold 504. For example, the anode unipolar plate 524 of the first substack 520 abuts the internal surface of the first manifold 502. The cathode unipolar plate 526 of the first substack 520 abuts the surface of the anode unipolar plate 544 of the second substack 540. The anode unipolar plate 564 of the third substack 560 abuts the surface of the cathode unipolar plate 546 of the second substack 540. Lastly, the cathode unipolar plate 566 of the third substack 560 abuts the internal surface of the second manifold 504. Thus, the plurality of substacks is positioned between the first manifold 502 and the second manifold 504.

As noted above, the respective unipolar plates advantageously enclose their respective plurality of cells to form the individual substacks 520, 540, and 560 in the electrochemical stack 500. The configuration advantageously allows the substacks to be independently tested for performance parameters and to be added to the electrochemical stack 500 only after achieving threshold test results (passing their tests).

Furthermore, following the independent testing of each individual substack and the addition of the substacks that passed their tests to the overall stack, the entire electrochemical stack may also be tested for one or more performance parameters. This may advantageously provide a second check or confirmation of the substacks included in the overall stack as well as provide an initial test of the interaction between the combined substacks.

In an alternative approach, the overall stack may be tested prior to the test of one or more of the substacks. To the extent the overall stack achieves desirable test results, individual testing of one or more substacks may be avoided. To the extent the overall stack fails one or more tests, individual testing of the substacks may be conducted, such as described above.

In either approach, individual cell testing is advantageously avoided, and troubleshooting of potential cell performance issues is streamlined/optimized.

The testing of the overall stack may be similar in nature to the testing of each individual substack. For example, the overall stack may be tested or examined for certain performance parameters such as substack alignment, cell isolation, cross-leak detection, hydrostatic leak detection, electrolysis at a current density greater than or equal to 3 Amp/cm², and/or electrolysis at a current density less than or equal to 3 Amp/cm².

### Methods of Forming an Electrochemical Stack

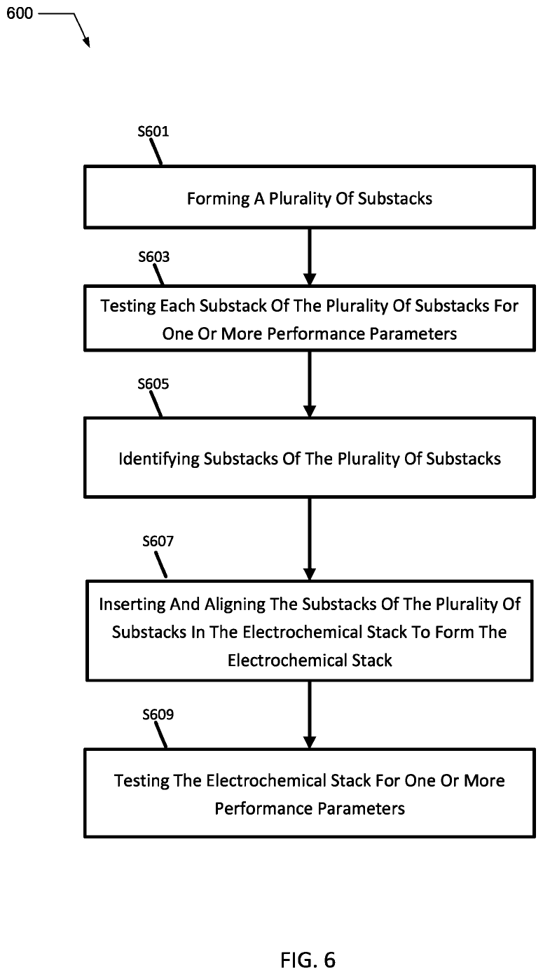

FIG. 6 depicts a flowchart describing an example process of forming an electrochemical stack. The process of forming an electrochemical stack may begin at S601 by forming a plurality of substacks. Each substack includes a plurality of electrochemical cells that are stacked on top of one another. Each substack also includes an anode unipolar plate and a cathode unipolar plate, wherein the plurality of electrochemical cells is positioned between the anode unipolar plate and the cathode unipolar plate.

As mentioned above, each electrochemical cell of the plurality of electrochemical cells in a substack includes a cathode flow field, an anode flow field, and a membrane positioned between the cathode flow field and the anode flow field. In certain examples, each electrochemical cell may further include a gas diffusion layer positioned between the cathode flow field and the membrane and a porous transport layer positioned between the anode flow field and the membrane. Additionally, in certain examples, the membrane may be a catalyst coated membrane (CCM) having a cathode catalyst layer and/or an anode catalyst layer positioned on respective surfaces of the membrane.

Furthermore, in certain examples, such as depicted in FIG. 4, a bipolar plate may be positioned at an interface between the anode flow field and the cathode flow field of respective adjacent electrochemical cells of the plurality of electrochemical cells.

Each substack is formed by layering or stacking individual plates or cell layers on top of another layer. For example, a process may commence by providing a first unipolar plate (e.g., a cathode unipolar plate) and then placing a cathode flow field layer of a first electrochemical cell on top. Subsequently, the additionally layers of the first cell are added. For example, the gas diffusion layer is added to the cathode flow field, followed by the CCM, followed by the porous transport layer, and concluded with the anode flow field of the first electrochemical cell.

Next, a bipolar plate may be added on top of the anode flow field, or the cathode flow field of the second cell may be added. The process may continue in this fashion until all the layers of the desired number of cells have been added to the substack. A second unipolar plate (e.g. an anode unipolar plate) is added on top to complete the substack.

In certain alternative examples, the layering of various plates/cells together may be conducted wherein certain groupings of cell layers are formed prior to the addition to the substack. For example, a cathode flow field may be positioned on a unipolar plate and then a group of cell layers (e.g., the gas diffusion layer, the membrane, and the porous transport layer) may be subsequently added to the cathode flow field, followed by the addition of the anode flow field, and then the various layers of the next cell, and so on.

In these processes, each layer/group of layers/plate is added and aligned with the adjacent layer within a defined threshold alignment tolerance (such that any misalignment between adjacent layers is less than the threshold alignment tolerance. Proper alignment of the layers is crucial to provide optimal performance and prevent issues that may arise due to misalignment.

Aligning the layers of the plurality of cells within each substack and stacking the substacks to form a stack, as compared to aligning cells within a stack, advantageously minimizes misalignment issues. For example, as noted above, an electrochemical stack having 360 cells in the stack may have a higher overall misalignment than a 10 cell substack because each individual cell's alignment affects the overall stack/substack. If any misalignments occur during assembly, they can add up to a greater overall misalignment for the stack.

However, by first aligning the layers within each substack, and then stacking these substacks together, the cumulative misalignment effect is reduced. The substacks act as more cohesive units, making it easier to achieve precise alignment within each one. Consequently, the overall electrochemical stack advantageously benefits from improved misalignment tolerance, leading to enhanced efficiency and reliability.

At S603, each substack of the plurality of substacks is tested for one or more parameters. For instance, each substack is configured to be independently tested for performance parameters and configured to only be added to the stack upon passing the individual tests, allowing for optimized identification and isolation of any problematic cells. By testing each substack individually rather than testing each electrochemical cell or only testing the overall stack, the process is optimized, making it easier to identify and address any performance-related issues in the electrochemical stack efficiently.

For example, each substack may be tested or examined for cell layer alignment, cell isolation, cross-leaks, hydrostatic leaks, electrolysis at a current density greater than or equal to 3 Amp/cm², or a combination thereof. Each substack then receives a threshold test result for one or more performance parameters. The threshold test result allows for easy identification of which substack of the plurality of substacks is performing efficiently and capable of being added to the stack.

At S605, certain substacks of the plurality of substacks are identified and added to the electrochemical stack based on the threshold test results. In other words, the results of these tests may determine which substacks meet the required criteria or performance thresholds and are therefore considered suitable for integration/addition to the electrochemical stack.

At S607, the identified substacks suitable for integration to the electrochemical stack are inserted and aligned to the electrochemical stack. More particularly, the plurality of substacks is stacked on top of one another to form the electrochemical stack. The plurality of substacks is stacked on top of one another and positioned between the first manifold and the second manifold.

For example, the substacks 520, 540, and 560, as depicted in FIG. 5, are stacked on top of one another and positioned between the first manifold 502 and the second manifold 504. The anode unipolar plate 524 of the first substack 520 abuts the internal surface of the first manifold 502. The cathode unipolar plate 526 of the first substack 520 abuts the exterior surface of the anode unipolar plate 544 of the second substack 540. The anode unipolar plate 564 of the third substack 560 abuts the internal surface of the cathode unipolar plate 546 of the second substack 540. Lastly, the cathode unipolar plate 566 of the third substack 560 abuts the internal surface of the second manifold 504. Thus, the plurality of substacks is positioned between the first manifold 502 and the second manifold 504.

As mentioned above, by aligning the cells within substacks and then aligning the substacks within the main stack, the configuration minimizes misalignment issues that occur when stacking multiple cells conventionally. This approach advantageously offers improved performance, reliability, and efficiency in the performance of an electrochemical stack.

At S609, the electrochemical stack, including the tested substacks, is also tested for one or more parameters. The electrochemical stack may be tested or examined for substack alignment, cell isolation, cross-leaks, hydrostatic leaks, electrolysis at a current density greater than or equal to 3 Amp/cm², electrolysis at a current density less than or equal to 3 Amp/cm², or a combination thereof. If the electrochemical stack fails to pass one or more parameters, each of the substacks may individually be tested to determine the problematic substack instead of testing each individual electrochemical cell in the stack. By testing each substack individually instead of testing each electrochemical cell separately, the process is streamlined and more efficient. This approach offers several advantages, such as simplified testing, performance identification, modularity and scalability, quality control, and fault isolation.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A substack for an electrochemical stack, the substack comprising:
a plurality of electrochemical cells, each electrochemical cell of the plurality of electrochemical cells comprising a cathode flow field, an anode flow field, and a membrane positioned between the cathode flow field and the anode flow field;
an anode unipolar plate; and
a cathode unipolar plate,
wherein the plurality of electrochemical cells is positioned between the anode unipolar plate and the cathode unipolar plate,
wherein the anode flow field of a first electrochemical cell abuts an internal surface of the anode unipolar plate,
wherein the cathode flow field of a second electrochemical cell abuts an internal surface of the cathode unipolar plate,
wherein the cathode flow field of the first electrochemical cell is positioned adjacent to the anode flow field of the second electrochemical cell or the anode flow field of an additional electrochemical cell positioned between the first and second electrochemical cells such that any additional electrochemical cells within the plurality of electrochemical cells are arranged where the anode flow field of a respective electrochemical cell is positioned adjacent to the cathode flow field of an adjacent electrochemical cell, and
wherein the substack is configured to be independently tested for one or more performance parameters prior to addition to the electrochemical stack, and
wherein the substack is configured to be added to the electrochemical stack comprising at least one additional substack following achieving a threshold test result for the one or more performance parameters being tested.

2. The substack of claim 1, further comprising:
a bipolar plate positioned at one or more interfaces between the anode flow field and the cathode flow field of respective adjacent electrochemical cells of the plurality of electrochemical cells.

3. The substack of claim 1, further comprising:
a bipolar plate positioned at each interface between the anode flow field and the cathode flow field of respective adjacent electrochemical cells of the plurality of electrochemical cells.

4. The substack of claim 1, wherein each electrochemical cell of the plurality of electrochemical cells further comprises:
a gas diffusion layer positioned between the cathode flow field and the membrane; and
a porous transport layer positioned between the anode flow field and the membrane.

5-6. (canceled)

7. The substack of claim 1, wherein the substack is configured to be tested or examined for cell layer alignment, cell isolation, cross-leaks, hydrostatic leaks, electrolysis at a current density greater than or equal to 3 Amp/cm², or a combination thereof.

8. (canceled)

9. The substack of claim 1, wherein the plurality of electrochemical cells within the substack is configured to operate with 200 mV or less of pure resistive loss when operating at a current density in a range of 3 Amps/cm² to 30 Amps/cm².

10. The substack of claim 1, wherein the substack is additionally configured to be removed from the electrochemical stack independently from the at least one additional substack present in the electrochemical stack.

11. An electrochemical stack comprising:
a first manifold;
a second manifold; and
a plurality of substacks stacked on top of one another and positioned between the first manifold and the second manifold,
wherein each substack of the plurality of substacks comprises:
a plurality of electrochemical cells, each electrochemical cell of the plurality of electrochemical cells comprising a cathode flow field, an anode flow field, and a membrane positioned between the cathode flow field and the anode flow field;
an anode unipolar plate; and
a cathode unipolar plate,
wherein the plurality of electrochemical cells is positioned between the anode unipolar plate and the cathode unipolar plate,
wherein the anode flow field of a first electrochemical cell abuts an internal surface of the anode unipolar plate,
wherein the cathode flow field of a second electrochemical cell abuts an internal surface of the cathode unipolar plate,
wherein the cathode flow field of the first electrochemical cell is positioned adjacent to the anode flow field of the second electrochemical cell or the anode flow field of an additional electrochemical cell positioned between the first and second electrochemical cells such that any additional electrochemical cells within the plurality of electrochemical cells are arranged where the anode flow field of a respective electrochemical cell is positioned adjacent to the cathode flow field of an adjacent electrochemical cell, and
wherein the substack is configured to be independently tested for one or more performance parameters prior to addition to the electrochemical stack, and
wherein the substack is configured to be added to the electrochemical stack comprising at least one additional substack following achieving a threshold test result for the one or more performance parameters being tested, and
wherein an anode unipolar plate of a first substack abuts an internal surface the first manifold,
wherein a cathode unipolar plate of a second substack abuts an internal surface of the second manifold, and
wherein the cathode unipolar plate of the first substack abuts the anode unipolar plate of the second substack or the anode unipolar plate of an additional substack positioned between the first and second substacks such that any additional substacks within the plurality of substacks are arranged where the anode unipolar plate of a respective substack is positioned adjacent to the cathode unipolar plate of an adjacent substack.

12. The electrochemical stack of claim 11, further comprising:
a bipolar plate positioned at one or more interfaces between the anode flow field and the cathode flow field of respective adjacent electrochemical cells of the plurality of electrochemical cells within one or more substacks of the plurality of substacks.

13. The electrochemical stack of claim 11, further comprising:
a bipolar plate positioned at each interface between the anode flow field and the cathode flow field of respective adjacent electrochemical cells of the plurality of electrochemical cells within each substack of the plurality of substacks.

14. The electrochemical stack of claim 11, wherein each electrochemical cell of the plurality of electrochemical cells within the plurality of substacks further comprises:
a gas diffusion layer positioned between the cathode flow field and the membrane; and
a porous transport layer positioned between the anode flow field and the membrane.

15-18. (canceled)

19. The electrochemical stack of claim 11, wherein the electrochemical stack is configured to be tested for at least one performance parameter following the independent testing of each individual substack of the plurality of substacks.

20. (canceled)

21. The electrochemical stack of claim 11, wherein the plurality of electrochemical cells within each substack of the plurality of substacks is configured to operate with 200 mV or less of pure resistive loss when operating at a current density in a range of 3 Amps/cm² to 30 Amps/cm².

22. The electrochemical stack of claim 11, wherein each substack of the plurality of substacks is additionally configured to be removed from the electrochemical stack independently from each additional substack of the plurality of substacks present in the electrochemical stack.

23. A method for forming an electrochemical stack, the method comprising:
forming a plurality of substacks, each substack comprising an anode unipolar plate, a cathode unipolar plate, and a plurality of electrochemical cells positioned between the anode unipolar plate and the cathode unipolar plate, wherein each electrochemical cell of the plurality of electrochemical cells in the substack includes a cathode flow field, an anode flow field, and a membrane positioned between the cathode flow field and the anode flow field;
testing each substack of the plurality of substacks for one or more performance parameters;
identifying substacks of the plurality of substacks for addition to the electrochemical stack following achieving a threshold test result for the one or more performance parameters being tested for the respective substack; and
inserting and aligning the substacks of the plurality of substacks that achieved the threshold test result on top of one another in the electrochemical stack to form the electrochemical stack,
wherein an anode unipolar plate of a first substack abuts an internal surface a first manifold of the electrochemical stack,
wherein a cathode unipolar plate of a second substack abuts an internal surface of a second manifold of the electrochemical stack, and
wherein the cathode unipolar plate of the first substack abuts the anode unipolar plate of the second substack or the anode unipolar plate of an additional substack positioned between the first and second substacks such that any additional substacks within the plurality of substacks are arranged where the anode unipolar plate of a respective substack is positioned adjacent to the cathode unipolar plate of an adjacent substack.

24. The method of claim 23, further comprising:
testing the electrochemical stack for at least one performance parameter.

25. The method of claim 24, wherein the electrochemical stack is tested or examined for substack alignment, cell isolation, cross-leaks, hydrostatic leaks, electrolysis at a current density greater than or equal to 3 Amp/cm², electrolysis at a current density less than or equal to 3 Amp/cm², or a combination thereof.

26. The method of claim 23, wherein each substack of the plurality of substacks is tested or examined for cell layer alignment, cell isolation, cross-leaks, hydrostatic leaks, electrolysis at a current density greater than or equal to 3 Amp/cm², or a combination thereof prior to the addition to the electrochemical stack.

27. The method of claim 23, wherein each substack of the plurality of substacks is formed by:
providing a first unipolar plate of a first electrochemical cell;
individually adding each layer of a plurality of layers of the first electrochemical cell on the first unipolar plate;
layering a first bipolar plate on top of the plurality of layers; and
repeating the individually adding of each layer of a plurality of layers of additional electrochemical cells and layering an additional bipolar plate;
individually adding each layer of a plurality of layers of a final electrochemical cell to the substack; and
providing a second unipolar plate to complete the substack.

28. The method of claim 27, wherein the forming of the plurality of substacks provides a reduction in an overall misalignment tolerance between a top and a bottom of the electrochemical stack in comparison with a cell stack having a same number of electrochemical cells that have been directly layered together without any substack formation.

29-30. (canceled)
